(19) United States
(12) Patent Application Publication
(10) Pub. No.: US 2008/0264402 A1
(43) Pub. Date: Oct. 30, 2008

(54) OVENS HAVING A COLD AIR RETURN BAFFLE AND METHODS FOR CIRCULATING AIR IN AN OVEN

(76) Inventor: Marcus E. BRAMHALL, Dallas, NC (US)

Correspondence Address: HESLIN ROTHENBERG FARLEY & MESITI PC, 5 COLUMBIA CIRCLE, ALBANY, NY, 12203, US

(21) Appl. No.: 12/111,497

(22) Filed: Apr. 29, 2008

Related U.S. Application Data
(60) Provisional application No. 60/915,012, filed on Apr. 30, 2007.

(51) Int. Cl. F24C 15/00; A21B 1/48; F28F 9/24; F28D 15/00

(52) U.S. Cl. 126/21 A; 99/443 C; 165/159; 165/104.28

(57) ABSTRACT

The present invention is directed to ovens for heat treating products and may include food preparation ovens for preparing pizza and similar types of food products. The ovens incorporates one or more cold air return baffles to elongate the flow of hot air across the surface to be heated as well as provide a stagnant heated air zone adjacent to the finger duct.

### CLAIM TO PRIORITY AND CROSS-REFERENCE TO RELATED APPLICATIONS

This application claims the benefit of U.S. Provisional Application No. 60/915,012, filed Apr. 30, 2007, entitled “Ovens, And Burner Tube Assemblies, Cold Air Return Baffles, Finger Ducts, And Removable Wheels Therefor”, which is hereby incorporated herein by reference in its entirety.

This application is related to commonly owned, and co-filed U.S. patent application Ser. No. ______, entitled “Ovens, Burner Tube Assemblies, And Methods For Delivering Air To A Gas Power Burner,” by Bramhall, (Docket No. 2869.015A); U.S. patent application Ser. No. ______, entitled “Ovens, Finger Ducts Therefor, And Methods for Distributing Air in a Finger Duct,” by Bramhall, (Docket No. 2869.015C); and U.S. patent application Ser. No. ______, entitled “Methods For Moving Ovens, And Ovens Having Means For Releasably Attaching To A Plurality Of Casters,” by Bramhall, (Docket No. 2869.015D), which are hereby incorporated herein by reference in their entirety.

### FIELD OF THE INVENTION

This invention relates generally to ovens, and more specifically, to cold air return baffles for regulating the circulation of heated air in ovens for heat treating products.

### BACKGROUND OF THE INVENTION

Ovens for heat treating products oftentimes employ a burner for combusting a fuel such as gas or electric means for heating the oven. Food preparation ovens such as food preparation ovens for preparing pizza and other types of food products typically employ jets of hot gaseous fluid such as hot air for baking or cooking the food product.

With reference to FIG. 1, in a portion of a conventional oven 100, air in a heating chamber 110 is pressured by a circulatory fan 120 and forced into finger ducts 130 and 132. The heated pressurized air is forced through a plurality of opening in the finger ducts and directed towards a surface 140 to be heated. Thereafter, the air is directed around the sides of the finger ducts to cold air returns 150 and 152 for return to heating chamber 110 to be heated again and forced into the finger ducts 130 and 132. As observed in FIG. 1, portions of the heated air discharged from the finger duct, illustrated by paths A, B, C, and D, only impinges a portion of the surface to be heated, i.e., “short cycled”, before the air is directed to the cold air return.

U.S. Pat. No. 6,880,545 issued to Heber et al. disclose a heating apparatus comprising two spaced apart pairs of spaced apart heated air distribution plenums disposed within a heating space and forming a return air conduit therebetween. More particularly, an return air conduit conveys air from a front wall of the heating space at the corners of the return air conduit into an air plenum such that the air is diffused horizontally to the full width of air plenum and the full height of the vertical distance between the spaced apart pairs of spaced apart heated air distribution plenums. The return air enters the return air conduit through return air inlet openings disposed at the corners of the return air conduit proximate the front wall. To reduce airflow resistance of return air into the return air conduit, the ends of the sidewalls disposed proximate the front wall are provided with inwardly oriented convex profiles.

U.S. Pat. No. 6,526,961 issued to Hardenburger discloses a conveyor oven having six separate return air ducts: two identical lower return air ducts and four identical top and middle return air ducts. Each of the return air ducts is rectangular in shape and made from thin stainless steel sheet metal and is open at each end. The top and middle return air ducts have openings in the bottom side while the lower return air duct has no openings.

U.S. Pat. No. 6,481,433 issued to Schjerven, Sr. et al. disclose a conveyor oven having upper and lower fingers. A conveyor passes between the fingers carrying food products which are baked by the heat of the hot air discharged from the fingers. After the hot air is emitted from the fingers, it passes between the fingers and into an air return plenum above and below the fingers.

U.S. Pat. No. 4,753,215 issued to Kaminski et al. disclose a low profile impingement oven having a conveyor. Air returns from an oven cavity through a space between the fingers, and along the outside walls of the oven to flow back to the axial fans. The air is then heated and is forced back through the plenums and into the respective fingers.

U.S. Pat. No. 6,539,934 issued to Moshonas et al. disclose a multiconveyor convection oven. Each set of finger ducts is mounted in parallel on a single plate removable from the baking chamber. The single plate has opposite side edges slidably receivable in a guide way provided on a corresponding sidewall of the baking chamber. The plate is also provided with a plurality of air inlets (corresponding to the length of the finger ducts) which are the air inlets of the air return passages to receive the air from the baking chamber.

U.S. Patent Application Publication No. 2006/0054155 by Bujeau et al. disclose a sealed oven having a door allowing food that is to be headed and/or cooked to be inserted in the oven. The oven includes a fan disposed inside the enclosure to stir the cooking atmosphere heated by a heater device. The fan creates a suction zone inside the enclosure, and an air inlet is situated substantially in the suction zone of the fan.

U.S. Pat. No. 6,655,373 issued to Wiker discloses a stack of three conveyor ovens. Each oven has a first section containing a cavity in the form of an open-ended tunnel extending therethrough. A draft of air is directed downwardly to “close” each of the open ends of the tunnel by deflecting currents of air within the oven which might otherwise carry heat away from the oven. An endless conveyor extends through each cavity or tunnel extending from an entrance to an exit.

There is a need for further ovens and regulation of the circulation of heated air in the ovens.

### SUMMARY OF THE INVENTION

The present invention, in a first aspect, is directed to an oven for heat treating a product. The oven includes a housing having a front sidewall, a rear sidewall, a right sidewall, a left sidewall, a top, a bottom, and an interior wall extending between the right sidewall and the left sidewall to define a first chamber and a second chamber in the housing. Means are provided for heating air in the first chamber. A first elongated finger duct in fluid communication with the first chamber receives heated air from the first chamber and discharges the heated air along a length of the finger duct in a first direction towards a surface to be heated in the second chamber. A first horizontal planar cold air return baffle extends between the right sidewall, the left sidewall, and the interior wall in the second chamber, and is spaced from the first elongated finger duct opposite from the first direction to define a first cold air return passageway between the first horizontal planar cold air return baffle and the top of the housing. The return passageway has an inlet adjacent to the front sidewall which extends the width of the finger duct so that the flow of heated air from the finger duct is elongated across the cooking surface towards the front sidewall and the flow of heated air is inhibited between the first finger duct and the first horizontal planar cold air return baffle thereby establishing a stagnant heated air zone.

The present invention, in a second aspect, is directed to a method for circulating air in an oven for heat treating a product. The method includes heating air in a first chamber in an oven, discharging heated air along a length of a first finger duct in a second chamber in the oven in a first direction towards a surface to be heated, creating a first stagnant heated air zone along the length and width of the first finger duct opposite from the first direction, directing the flow of heated air along the heated surface toward the end of the first finger duct, directing the flow of heated air along the width of the first finger duct adjacent to the distal end of the first finger duct around the first stagnant heated air zone, and returning the directed flow of heated air around the first stagnant heated air zone back to the first chamber to be reheated.

The present invention, in a third aspect, is directed to an oven for heat treating a product. The oven includes a housing having a front sidewall, a rear sidewall, a right sidewall, a left sidewall, a top, a bottom, an interior wall extending between the right sidewall and the left sidewall to define a first chamber and a second chamber in the housing, and a divider extending between the interior wall and the front sidewall and spaced from a surface to be heated. Means is provided for heating air in the first chamber. At least one first elongated finger duct is disposed between the right sidewall and the divider in fluid communication with the first chamber for receiving heated air from the first chamber and discharging the heated air along a length of the finger duct in a first direction towards the surface to be heated in the second chamber. A first horizontal planar cold air return baffle extends between the right sidewall, the divider, and the interior wall in the second chamber, and spaced from the at least one first elongated finger duct opposite from the first direction to define a first cold air return passageway between the first horizontal planar cold air return baffle and the top of the housing. The first cold air return passageway has an inlet adjacent to the front sidewall which extends the width of the finger duct so that the flow of heated air from the finger duct is elongated across the surface to be heated toward the front sidewall and the flow of heated air is inhibited between the first finger duct and the first horizontal planar cold air return baffle thereby establishing a first stagnant heated air zone. At least one second elongated finger duct is disposed between the left sidewall and the divider in fluid communication with the first chamber for receiving heated air from the first chamber and discharging the heated air along a length of the at least one second finger duct in the first direction towards the surface to be heated in the second chamber. A second horizontal planar cold air return baffle extends between the left sidewall, the divider, and the interior wall in the second chamber, and is spaced from the at least one second elongated finger duct opposite from the first direction to define a second cold air return passageway between the second horizontal planar cold air return baffle and the top of the housing. The second cold air return passageway has an inlet adjacent to the front sidewall which extends the width of the second finger duct so that the flow of heated air from the second finger duct is elongated across the surface to be heated toward the front sidewall and the second flow of heated air is inhibited between the second finger duct and the second horizontal planar cold air return baffle thereby establishing a second stagnant heated air zone.

The present invention, in a fourth aspect, is directed to a method for circulating air in an oven for heat treating a product. The method includes heating air in a first chamber in an oven, discharging heated air along a length of a plurality of spaced apart finger ducts in a second chamber in the oven in a first direction towards a surface to be heated, creating a plurality of stagnant heated air zones along the length and width of the plurality of finger ducts opposite from the first direction, directing the flow of heated air along the heated surface toward the end of the plurality of finger ducts, directing the flow the heated air adjacent to the distal ends of each of the plurality of finger ducts and along the width of the finger ducts around a respective corresponding one of the stagnant heated air zones, and returning the directed flow of heated air around the stagnant heated air zones back to the first chamber to be reheated.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is diagrammatic side elevational view of a portion of a prior art oven illustrating a “short cycling” flow of heated air through the oven;

FIG. 2 is a front perspective view of one embodiment of an oven in accordance with the present invention;

FIG. 3 is diagrammatic side elevational view of a portion of the oven of FIG. 2 having cold air return baffles and illustrating the flow of heated air through the oven in accordance with the present invention;

FIG. 4 is an end view of the portion of the oven of FIG. 3;

FIG. 5 is a top view of the oven of FIG. 3;

FIG. 6 is a perspective view of the cold air return baffle installed in the oven of FIG. 2;

FIG. 7 is a plan view of the cold air return baffle of FIG. 6;

FIGS. 8 and 9 are further plan views of two embodiments of cold air return baffles in accordance with the present invention having different proportions;

FIG. 10 is a flowchart of one embodiment of a method for circulating air in an oven in accordance with the present invention; and

FIG. 11 is a flowchart of an alternative embodiment of a method for circulating air in an oven in accordance with the present invention.

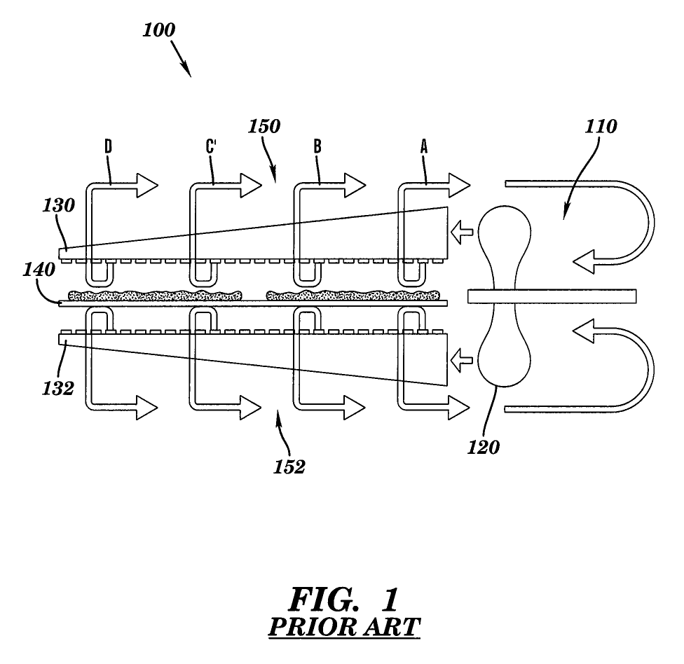

### DETAILED DESCRIPTION OF THE INVENTION

The present invention is directed to ovens for heat treating products and may include ovens for heat treating products such as ovens for preparing pizza and similar types of food products. For example, the ovens may be configured as an impingement oven having a conveyor wherein food products are baked or cooked by means of jets of hot gaseous fluid such as hot air and wherein the hot air jets are impinged directly upon localized areas of the food product.

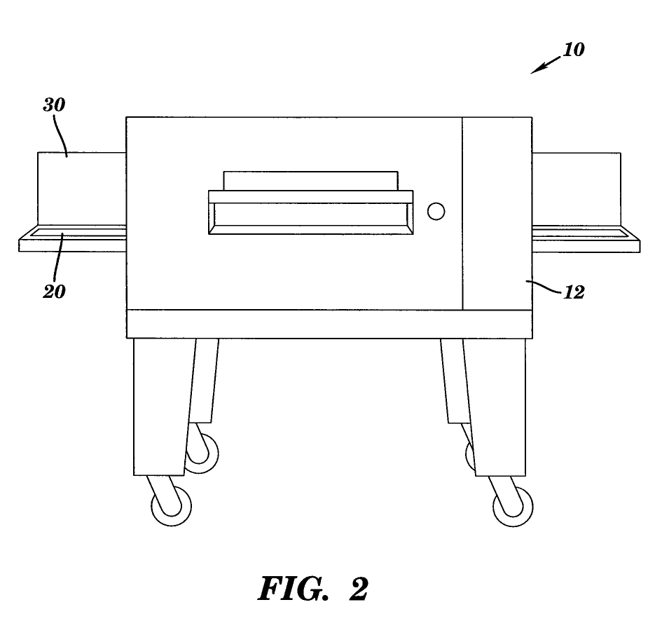

FIG. 2 illustrates an oven 10 in accordance with the present invention for heat treating products and may include an oven for preparing pizza and similar types of food products. For example, a gas power burner may be used in the oven 10 having a housing 12 having a conveyor 20 wherein food products are baked or cooked by means of jets of hot gaseous fluid such as hot air and wherein the hot air jets are impinged directly upon localized areas of the food product. Alternatively, an electrical heating element or means may be employed instead of the gas burner. A shroud 30 covers a conveyor drive motor operatively connected via a gear motor, a sprocket, and a chain, for moving the conveyor. It will be appreciated that a plurality of such ovens may be employed in a stacked configuration.

In one aspect, the present invention is directed to ovens which include a cold air return baffle (not shown in FIG. 2) to elongate the flow of hot air across the cooking surface instead of allowing heated air to flow into the cold air return prematurely. For example, in oven 10, air in a heating chamber is pressured by a circulatory fan and forced into finger ducts. The heated pressurized air is forced through a plurality of opening in the finger ducts and directed towards a surface to be heated. Thereafter, the air is directed around the finger duct for return to the heating chamber to be heated again and then forced into the finger ducts.

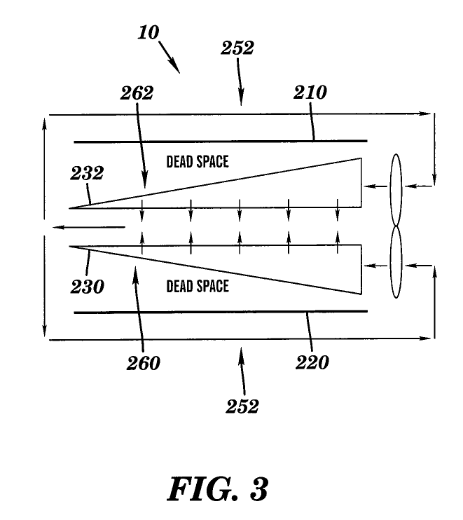

As best shown in FIGS. 3-5, oven 10 includes a housing having a front sidewall 100, a rear sidewall 110, a right sidewall 120, a left sidewall 130, a top 140, and a bottom 150. An interior wall 160 extends between the right sidewall and the left sidewall to define a first chamber 170 and a second chamber 180. Cold air return baffles 210 and 220 in accordance with the present invention are disposed above and below finger ducts 230 and 232 so that the heated air discharged from plurality of openings in the finger ducts is prevented from “short cycling” and made to travel generally along the length of the finger ducts to the end of the cold air return baffle, i.e., “long cycling.” For example, the heated air discharged from the finger duct adjacent to the fan is made to travel generally along the width of the cooking surface prior to entering the cold air return.

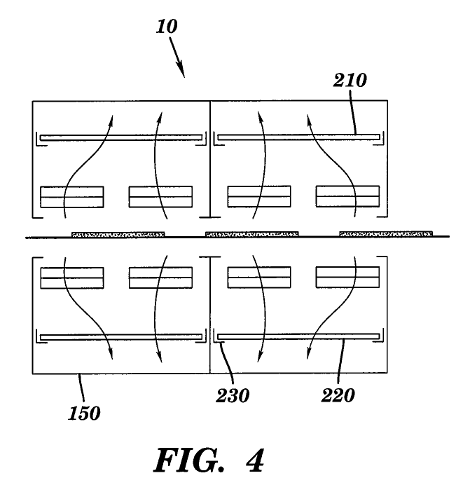

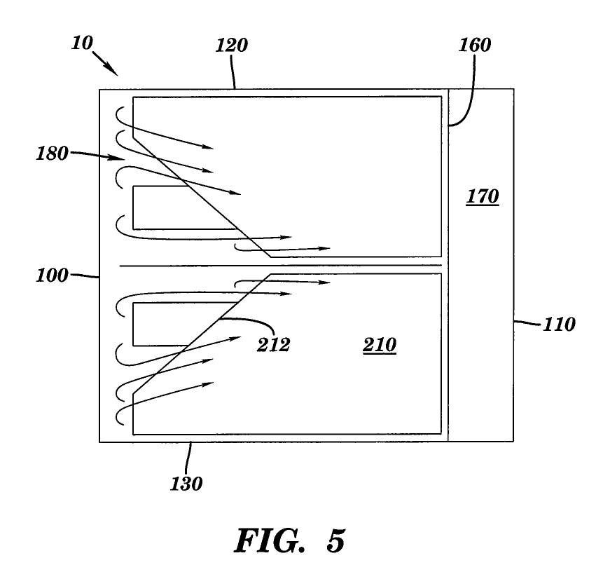

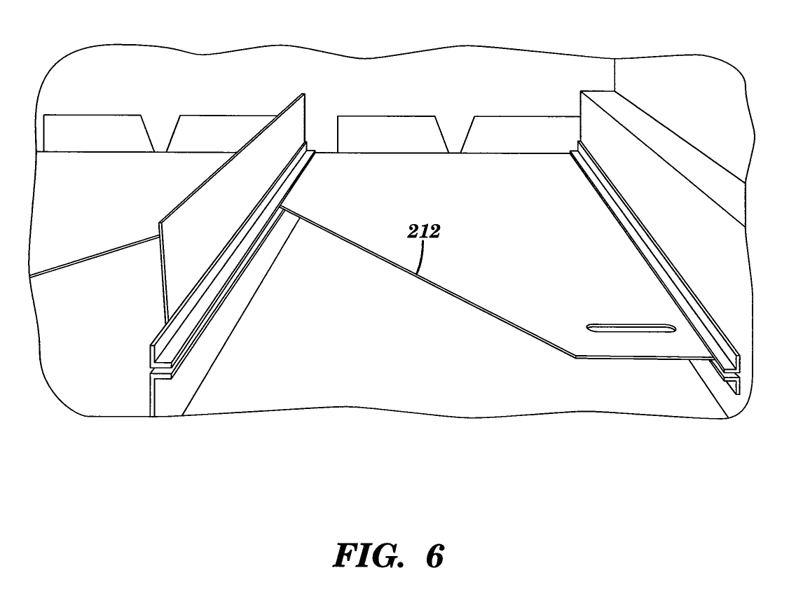

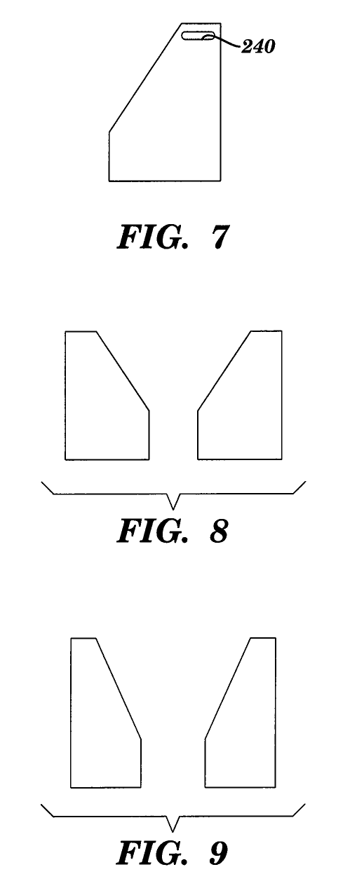

As shown in FIG. 4, the sides of cold air return baffle 210 may be releasably and removably supported in the oven on L-shaped brackets 230 or in channels. The tapered end of the baffle is spaced about 1½ inches from the inside edge of the oven as shown in FIG. 5. As shown in FIGS. 5 and 6, the cold air return baffle 210 includes a cutout or angled edge 212. In addition, the tapered end of the cold air return baffle may have an opening 240 that acts as a handle, as shown in FIG. 7, for use by a user in installing and removing the cold air return baffle from the oven. The edges of the cold air return baffle may be rolled over to stiffen the baffle.

With reference again to FIG. 3, the use of the cold air return baffle results in a dead space or stagnant heated air zones 260 and 262 which aids in the heated air traveling across the width of the oven or length of the finger ducts before entering the cold air return. In addition, the cutout results in the air being rolled inward or pulled toward the middle or center of the oven as it enters the cold air return as illustrated in FIG. 5. The cutout may be about 15-percent to about 25-percent of the cold air return baffle. The cutout also limits the hot air exiting the openings of the oven in which the product to be heated is introduced or exited, for example, via the conveyor. Tests have shown that a constant temperature and pressure may be maintained across the width of the oven as the food is carried through the oven. FIGS. 8 and 9 further illustrate the configuration of additional embodiments of the cold air return baffles. It will be appreciated that other cold air return baffles having different proportions for the sides and the cutout may be suitably employed.

The use of cold air return may increase the efficiency in heating food in the oven and reduce the amount of energy or fuel such as gas needed compared to conventional short cycling ovens.

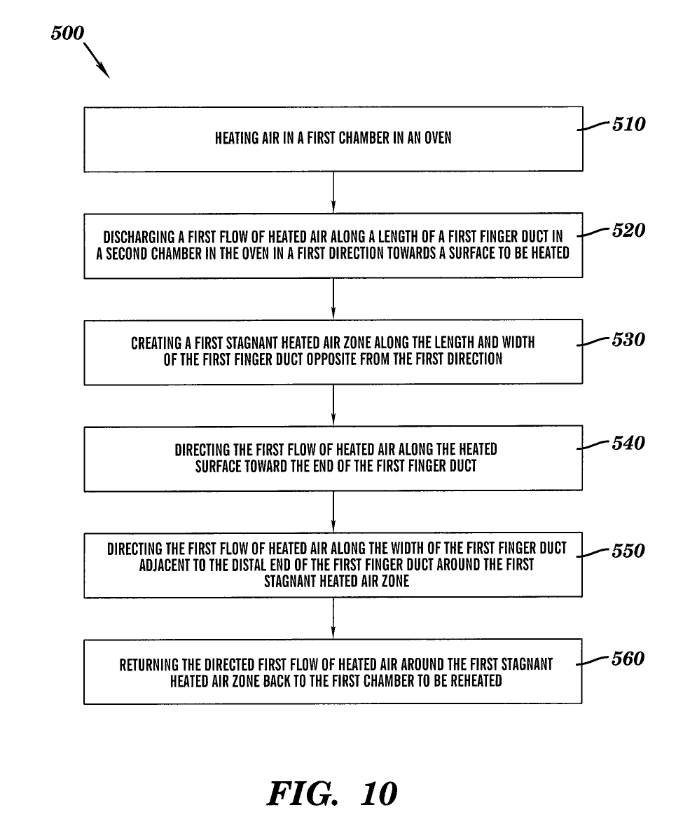

FIG. 10 illustrates a flowchart of a method 500 for circulating air in an oven in accordance with the present invention for heat treating a product. Method 500 includes heating air in a first chamber in an oven at 510, and at 520, discharging a first flow of heated air along a length of a first finger duct in a second chamber in the oven in a first direction towards a surface to be heated. At 530, a first stagnant heated air zone is created along the length and width of the first finger duct opposite from the first direction. The first flow of heated air is directed along the heated surface toward the end of the first finger duct at 540. The first flow of heated air is directed along the width of the first finger duct adjacent to the distal end of the first finger duct around the first stagnant heated air zone at 550, and at 560, the directed first flow of heated air is returned around the first stagnant heated air zone back to the first chamber to be reheated.

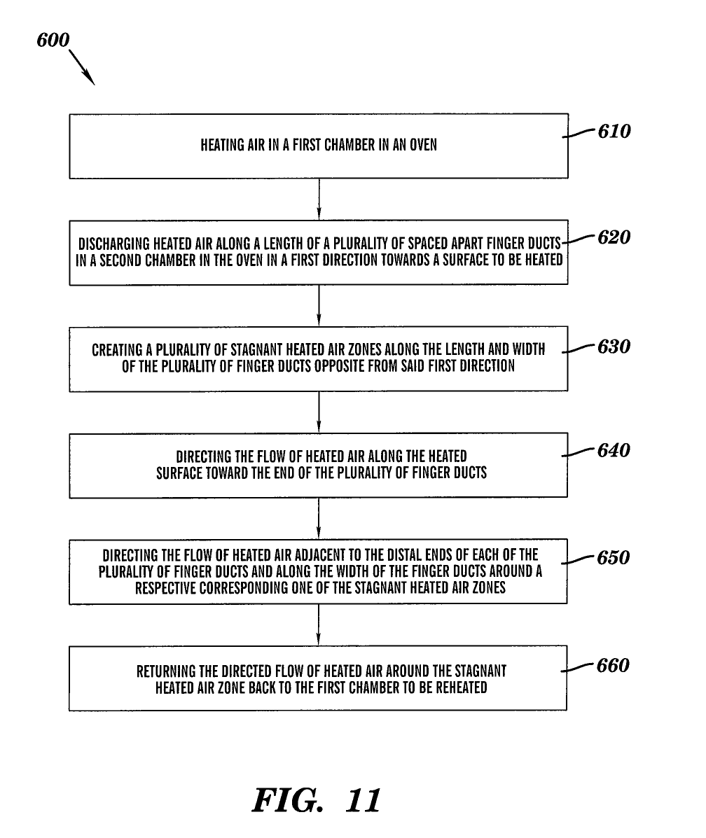

FIG. 11 illustrates a flowchart of another method 600 for circulating air in an oven in accordance with the present invention for heat treating a product. Method 600 includes heating air in a first chamber in an oven at 610, and at 620, discharging heated air along a length of a plurality of spaced apart finger ducts in a second chamber in the oven in a first direction towards a surface to be heated. At 630, a plurality of stagnant heated air zones is created along the length and width of the plurality of finger ducts opposite from said first direction. The flow of heated air is directed along the heated surface toward the end of the plurality of finger ducts, at 640. The flow the heated air adjacent to the distal ends of each of the plurality of finger ducts along the width of the finger ducts is directed around a respective corresponding one of the stagnant heated air zones at 650, and at 660 the directed flow of heated air around the stagnant heated air zone is returned to the first chamber to be reheated.

The various components of the present invention described above may be incorporated into the food preparation ovens disclosed in U.S. Pat. No. 4,846,143 issued to Csadenyl, U.S. Pat. No. 5,025,775 issued to Crisp, and applicant's co-filed U.S. patent applications as noted above, the entire subject matter of these patents and applications being incorporated herein by reference.

Thus, while various embodiments of the present invention have been illustrated and described, it will be appreciated to those skilled in the art that many changes and modifications may be made thereunto without departing from the spirit and scope of the invention.

1. An oven for heat treating a product, said oven comprising:
a housing having a front sidewall, a rear sidewall, a right sidewall, a left sidewall, a top, a bottom, and an interior wall extending between said right sidewall and said left sidewall to define a first chamber and a second chamber in said housing;
means for heating air in said first chamber;
a first elongated finger duct in fluid communication with said first chamber for receiving heated air from said first chamber and discharging the heated air along a length of said finger duct in a first direction towards a surface to be heated in said second chamber;
a first horizontal planar cold air return baffle extending between said right sidewall, said left sidewall, and said interior wall in said second chamber, and spaced from said first elongated finger duct opposite from said first direction to define a first cold air return passageway between said first horizontal planar cold air return baffle and said top of said housing, said first cold air return passageway having an inlet adjacent to said front sidewall which extends the width of the finger duct so that the flow of heated air from said finger duct is elongated across the surface to be heated toward said front sidewall and the flow of heated air is inhibited between said first finger duct and said first horizontal planar cold air return baffle thereby establishing a first stagnant heated air zone.

2. The oven of claim 1 wherein said cold air return baffle comprises an angled edge adjacent to said front sidewall for directing the flow of heated air towards the angle edge.

3. The oven of claim 1 wherein said oven comprises a first opening in said right sidewall and a second opening in said left sidewall, and a conveyor for transporting the product to be heated into and out of the oven through said openings.

4. The oven of claim 1 wherein said cold air return baffle is slidably removable from said oven.

5. The oven of claim 1 wherein said first elongated finger duct discharges heated air in a first directions downwardly onto the surface to be heated, and further comprising:
a second elongated finger duct in fluid communication with said first chamber for receiving heated air from said first chamber and discharging the heated air along a length of said second finger duct in a second direction upwardly towards the surface to be heated in said second chamber; and
a second horizontal planar cold air return baffle extending between said right sidewall, said left sidewall, and said interior wall in said second chamber, and spaced from said second elongated finger duct below said second finger duct to define a second cold air return passageway between said second horizontal planar cold air return baffle and said bottom of said housing, said second cold air return passageway having an inlet adjacent to said front sidewall and extending the width of the second finger duct so that the flow of heated air from said second finger duct is elongated across the surface to be heated toward said front sidewall and the flow of heated air is inhibited between said second finger duct and said second horizontal planar cold air return baffle thereby establishing a second stagnant heated air zone.

6. The oven of claim 5 wherein said cold air return baffle comprises an angled edge adjacent to said front sidewall for directing the flow of heated air towards the angle edge.

7. The oven of claim 6 wherein said cold air return baffles comprise an opening adjacent said angled edge to define a handle.

8. The oven of claim 5 wherein said oven comprises a first opening in said right sidewall and a second opening in said left sidewall, and a conveyor defining said surface to be heated for transporting the product to be heated into and out of the oven through said openings.

9. The oven of claim 5 wherein said cold air return baffles are slidably removable from said oven.

10. A method for circulating air in an oven for heat treating a product, the method comprising:
heating air in a first chamber in an oven;
discharging a first flow of heated air along a length of a first finger duct in a second chamber in the oven in a first direction towards a surface to be heated;
creating a first stagnant heated air zone along the length and width of the first finger duct opposite from the first direction;
directing the first flow of heated air along the heated surface toward the end of the first finger duct;
directing the first flow of heated air along the width of the first finger duct adjacent to the distal end of the first finger duct around the first stagnant heated air zone; and
returning the directed first flow of heated air around the first stagnant heated air zone back to the first chamber to be reheated.

11. The method of claim 10 wherein the directing the first flow of heated air adjacent to the distal end of the finger duct and along the width of the first finger duct around the first stagnant heated air zone comprises directing the first flow of heated air adjacent to the distal end of the finger duct on an angle along the width of the first finger duct around the first stagnant heated air zone.

12. The method of claim 10 further comprising:
discharging a second flow of heated air along a length of a second finger duct in a second chamber in the oven in a second direction opposite from the first direction upwardly towards the surface to be heated;
creating a second stagnant heated air zone along the length and width of the second finger duct opposite from the second direction;
directing the second flow of heated air along the heated surface toward the end of the second finger duct;
directing the second flow of heated air along the width of the second finger duct adjacent to the distal end of the second finger duct around the second stagnant heated air zone; and
returning the directed second flow of heated air around the second stagnant heated air zone back to the first chamber to be reheated.

13. The method of claim 12 wherein the directing the first flow of heated air adjacent to the distal end of the finger duct and along the width of the first finger duct around the first stagnant heated air zone comprises directing the first flow of heated air adjacent to the distal end of the first finger duct on an angle along the width of the first finger duct around the first stagnant heated air zone, and directing the second flow of heated air adjacent to the distal end of the second finger duct and along the width of the second finger duct around the second stagnant heated air zone comprises directing the second flow of heated air adjacent to the distal end of the second finger duct on an angle along the width of the second finger duct around the second stagnant heated air zone.

14. An oven for heat treating a product, said oven comprising:
a housing having a front sidewall, a rear sidewall, a right sidewall, a left sidewall, a top, a bottom, an interior wall extending between said right sidewall and said left sidewall to define a first chamber and a second chamber in said housing, and a divider extending between said interior wall and said front sidewall and spaced from a surface to be heated;
means for heating air in said first chamber;
at least one first elongated finger duct disposed between said right sidewall and said divider in fluid communication with said first chamber for receiving heated air from said first chamber and discharging the heated air along a length of said finger duct in a first direction towards the surface to be heated in said second chamber;
a first horizontal planar cold air return baffle extending between said right sidewall, said divider, and said interior wall in said second chamber, and spaced from said at least one first elongated finger duct opposite from said first direction to define a first cold air return passageway between said first horizontal planar cold air return baffle and said top of said housing, said first cold air return passageway having an inlet adjacent to said front sidewall and extending the width of the first finger duct so that the first flow of heated air from said first finger duct is elongated across the surface to be heated toward said front sidewall and the flow of heated air is inhibited between said first finger duct and said first horizontal planar cold air return baffle thereby establishing a first stagnant heated air zone.
at least one second elongated finger duct disposed between said left sidewall and said divider in fluid communication with said first chamber for receiving heated air from said first chamber and discharging the heated air along a length of said at least one second finger duct in the first direction towards the surface to be heated in said second chamber;
a second horizontal planar cold air return baffle extending between said left sidewall, said divider, and said interior wall in said second chamber, and spaced from said at least one second elongated finger duct opposite from the first direction to define a second cold air return passageway between said second horizontal planar cold air return baffle and said top of the housing, said second cold air return passageway, said second cold air return passageway having an inlet adjacent to said front sidewall and extending the width of the second finger duct so that the flow of heated air from said second finger duct is elongated across the surface to be heated toward said front sidewall and the second flow of heated air is inhibited between said second finger duct and said second horizontal planar cold air return baffle thereby establishing a second stagnant heated air zone.

15. The oven of claim 14 wherein said cold air return baffles comprise an angled edge adjacent to said front sidewall and said divider for directing the flow of heated air towards the center of the oven.

16. The oven of claim 14 wherein said oven comprises a first opening in said right sidewall and a second opening in said left sidewall, and a conveyor for transporting the product to be heated into and out of the oven through said openings.

17. The oven of claim 14 wherein said cold air return baffles are slidably removable from said oven.

18. The oven of claim 14 wherein said at least one first elongated finger duct discharges heated air in the first direction downwardly onto the surface to be heated, and wherein said at least one second elongated finger duct discharges heated air in the first direction downwardly onto the surface to be heated, and further comprising:
at least one third elongated finger duct in fluid communication with said first chamber for receiving heated air from said first chamber and discharging the heated air along a length of said at least one third finger duct in a second direction upwardly towards the surface to be heated in said second chamber, a third horizontal planar cold air return baffle extending between said right sidewall, said divider, and said interior wall in said second chamber, and spaced from said at least one third elongated finger duct below said third finger duct to define a third cold air return passageway between said third horizontal planar cold air return baffle and said bottom of said housing, said third cold air return passageway having an inlet adjacent to said front sidewall extending the width of the third finger duct so that the third flow of heated air from said third finger duct is elongated across the surface to be heated toward said front sidewall and the third flow of heated air is inhibited between said third finger duct and said third horizontal planar cold air return baffle thereby establishing a third stagnant heated air zone;
at least one fourth elongated finger duct in fluid communication with said first chamber for receiving heated air from said first chamber and discharging the heated air along a length of said at least one fourth finger duct in the second direction upwardly towards the surface to be heated in said second chamber; and
a fourth horizontal planar cold air return baffle extending between said left sidewall, said divider, and said interior wall in said second chamber, and spaced from said at least one fourth elongated finger duct below said fourth finger duct to define a fourth cold air return passageway between said fourth horizontal planar cold air return baffle and said bottom of said housing, said fourth cold air return passageway having an inlet adjacent to said front sidewall extending the width of the fourth finger duct so that the fourth flow of heated air from said fourth finger duct is elongated across the surface to be heated toward said front sidewall and the fourth flow of heated air is inhibited between said fourth finger duct and said fourth horizontal planar cold air return baffle thereby establishing a fourth stagnant heated air zone.

19. The oven of claim 18 wherein said cold air return baffles comprise an angled edge adjacent to said front sidewall and said divider for directing the flow of heated air towards the center of the oven.

20. The oven of claim 18 wherein said oven comprises a first opening in said right sidewall and a second opening in said left sidewall, and a conveyor for transporting the product to be heated into and out of the oven through said openings.

21. The oven of claim 18 wherein said cold air return baffles are slidably removable from said oven.

22. A method for circulating air in an oven for heat treating a product, the method comprising:
heating air in a first chamber in an oven;
discharging heated air along a length of a plurality of spaced apart finger ducts in a second chamber in the oven in a first direction towards a surface to be heated;
creating a plurality of stagnant heated air zones along the length and width of the plurality of finger ducts opposite from said first direction,
directing the flow of heated air along the heated surface toward the end of the plurality of finger ducts;
directing the flow the heated air adjacent to the distal ends of each of the plurality of finger ducts and along the width of the finger ducts around a respective corresponding one of the stagnant heated air zones; and
returning the directed flow of heated air around the stagnant heated air zone back to the first chamber to be reheated.

23. The method of claim 22 further comprising directing the flow of heated air adjacent to the distal end of adjacent finger ducts on an angle toward each other along the width of the finger ducts and around the stagnant heated air zones.

24. The method of claim 22 wherein the first direction towards a surface to be heated comprises downwardly towards the surface to be heated, and further comprising:
discharging heated air along a length of a second plurality of spaced apart finger ducts in the second chamber in the oven in a upwardly towards a surface to be heated;
creating a second plurality of stagnant heated air zones along the length and width of the second plurality of finger duct below the second plurality of finger ducts;
directing the flow of heated air along the heated surface toward the end of the second plurality of finger ducts;
directing the flow the heated air adjacent to the distal ends of each of the second plurality of finger ducts and along the width of the plurality of second finger ducts around a respective corresponding one of the second stagnant heated air zone; and
returning the directed flow of heated air around the stagnant heated air zone back to the first chamber to be reheated.

25. The method of claim 24 further comprising directing the flow of heated air adjacent to the distal end of adjacent finger ducts on an angle toward each other along the width of the finger duct and around the stagnant heated air zone, and directing the flow of heated air adjacent to the distal end of adjacent finger ducts of said second plurality of finger ducts on an angle toward each other along the width of the finger duct and around the second stagnant heated air zone.
